(19) United States
(12) Patent Application Publication
(10) Pub. No.: US 2018/0154772 A1
(43) Pub. Date: Jun. 7, 2018

(54) DRIVELINE DISCONNECT USING MULTIMODE CLUTCHES

(71) Applicant: BorgWarner Inc., Auburn Hills, MI (US)

(72) Inventors: CHRISTOPHER E. BLAIR, Fenton, MI (US); BRETT J. LEE, Portland, OR (US)

(21) Appl. No.: 15/576,565

(22) PCT Filed: May 21, 2016
(86) PCT No.: PCT/US2016/033672

§ 371 Date: Nov. 22, 2017

Related U.S. Application Data
(60) Provisional application No. 62/167,749, filed on May 28, 2015.

(51) Int. Cl. B60K 17/35; B60K 17/02; B60K 23/08; B60K 17/346

(52) U.S. Cl. CPC B60K 17/35; B60K 17/02; B60K 23/0808; B60Y 2400/42; B60K 2023/0825; B60K 2023/0833; B60K 17/3462

(57) ABSTRACT

In an all-wheel drive (AWD) vehicle (10,42), torque carrying connections are provided between the powertrain and all four wheels (12,14, 22,24). A multimode mechanical clutch (48) or clutches are provided to selectively disconnect two of the wheels (12,14,22,24) from the powertrain during operating conditions where disconnection improves the performance and efficiency of the AWD vehicle (10, 42). The multimode mechanical clutches (48) may be installed at various locations of the AWD vehicle (10,42), such as within a front or rear differential (20,30), between a half axle (16,18,26,28) and a differential (20, 30) or between a half axle (16,18,26,28) and a corresponding wheel (12,14,22,24), or within a transfer case (36) or power transfer unit (44).

### REFERENCE TO RELATED APPLICATION

This application is an International Patent Application claiming priority under U.S. 35 U.S.C. § 119(e) to U.S. Provisional Patent Application No. 62/167,749 filed on May 28, 2015.

### of the Disclosure

This disclosure relates generally to all-wheel drive (AWD) vehicles having an engine, a transmission and power transfer to both front and rear sets of drive wheels, and in particular to an AWD vehicle having a multimode mechanical clutch selectively connecting and disconnecting one set of drive wheels from the driveline when the AWD function is not required.

### BACKGROUND OF THE DISCLOSURE

AWD vehicles as known in the art provide increased traction and stability by providing power to all four wheels in contrast to two-wheel drive vehicles that provide power to only the front wheels or the rear wheels. To provide power to all four wheels, an AWD vehicle requires torque transferring connections between the powertrain and all four wheels. In one exemplary AWD vehicle, a transmission output shaft may be connected to a transfer case that splits torque from the vehicle's power source, such as an internal combustion engine or an electric motor, between a rear wheel drive shaft and rear differential and a front wheel drive shaft and front differential.

The AWD functionality is useful in handling driving over varying types of terrains and driving conditions. Providing power to all four wheels may ensure that power is transmitted to the surface even when one or more wheels are not in contact with the surface. Moreover, distributing the torque from the powertrain across all four wheels may reduce wheel slippage on slippery surfaces where directing torque to only two wheels can cause those wheels to slip or skid. However, for fuel economy reasons, it may be desirable to disconnect one set of drive wheels and reduce transfer case and differential losses when the AWD function is not required. For example, it is not necessary to drive all four wheels when on the vehicle is cruising on a road or highway in normal dry conditions.

In previous AWD vehicles, one of the sets of drive wheels may be selectively disengaged from the powertrain by the use of a dog clutch or a friction clutch. Friction clutches typically transmit torque between the coupled components for rotation in both directions when engaged, and unlock the components to rotate freely in both directions when disengaged. Dog clutches may selectively lock the components in both directions for rotation together. As is apparent, these clutches provide two modes of connections (modulated two-way torque distribution/two-way unlock or two-way lock/two-way unlock) between a set of wheels and the powertrain. However, conditions may exist where it may be desirable to offer either two-way lock/one-way unlock or all three modes in connecting the powertrain to the set of driven wheels. At present, such functionality may only be achievable with multiple clutches. In view of this, a need exists for a clutching arrangement in AWD vehicles with the flexibility to provide clutching modes not previously achieved with the common AWD vehicle clutch devices as described above.

### SUMMARY OF THE DISCLOSURE

In one aspect of the present disclosure, an AWD vehicle is disclosed. The AWD vehicle may include a first set of driven wheels, a second set of driven wheels, a power source, and a transmission operatively connected to the power source and receiving power output by the power source, and having a transmission output shaft. The AWD vehicle may further include a first wheel driveline operatively connected between the power source output shaft and the first set of driven wheels to transfer power from the power source to rotate the first set of driven wheels, a second wheel driveline operatively connected between the power source output shaft and the second set of driven wheels to transfer power from the power source to rotate the first set of driven wheels, and a multimode clutch within the first wheel driveline to allow the first driveline to selectively transmit power from the power source to the first set of driven wheels. The multimode clutch may have a first mode wherein the multimode clutch transmits torque from the power source to the first set of driven wheels when the transmission shaft rotates in either direction, a second mode wherein the multimode clutch does not transmit torque from the power source to the first set of driven wheels when the transmission shaft rotates in either directions, and a third mode wherein the multimode clutch transmits torque from the power source to the first set of driven wheels when the transmission shaft rotates in one direction and does not transmit torque from the power source when the transmission shaft rotates in the other direction.

In another aspect of the present disclosure, an AWD vehicle is disclosed. The AWD vehicle may include a first set of driven wheels, a second set of driven wheels, a power source, and a transmission operatively connected to the power source and receiving power output by the power source, the transmission having a transmission output shaft. The AWD vehicle may further include a first wheel driveline operatively connected between the power source output shaft and the first set of driven wheels to transfer power from the power source to rotate the first set of driven wheels, a second wheel driveline operatively connected between the power source output shaft and the second set of driven wheels to transfer power from the power source to rotate the second set of driven wheels, and a multimode clutch within the first wheel driveline to allow the first driveline to selectively transmit power from the power source to the first set of driven wheels. The multimode clutch may have a first mode wherein the multimode clutch transmits torque from the power source to the first set of driven wheels when the transmission shaft rotates in either direction, a second mode wherein the multimode clutch does not transmit torque from the power source to the first set of driven wheels when the transmission shaft rotates in either directions, and a third mode wherein the multimode clutch transmits torque from from the power source to the first set of driven wheels when the transmission shaft rotates in one direction and does not transmit torque from the power source when the transmission shaft rotates in the other direction. The AWD vehicle may also include a multimode clutch actuator operatively connected to the multimode clutch and configured to selectively place the multimode clutch in the first mode, the second mode and the third mode, and a controller operatively connected to the multimode clutch actuator, with the controller being configured to transmit clutch mode control signals to the multimode clutch actuator to cause the multimode clutch actuator to place the multimode clutch in the first mode, the second mode and the third mode.

In a further aspect of the present disclosure, a differential for an AWD vehicle is disclosed. The AWD vehicle may have a first driven wheel mounted on a first half shaft, second driven wheel mounted on a second half shaft, and a wheel drive shaft operatively connected to a transmission output shaft of a transmission that receives power from a power source of the AWD vehicle. The differential may include a pinion gear operatively connected to the wheel drive shaft, a first side gear operatively connected to the first half shaft, a second side gear operatively connected to the second half shaft, a ring gear meshing with the pinion gear, a first spider gear and a second spider gear meshing with the first side gear and the second side gear, and a differential case connected to the ring gear and having the first spider gear and the second spider gear mounted thereto. The differential may further include a multimode clutch allowing the differential to selectively transmit power from the power source to the first driven wheel and the second driven wheel, with the multimode clutch having a first mode wherein the multimode clutch transmits torque from the wheel drive shaft to the first driven wheel and the second driven wheel when the wheel drive shaft rotates in either direction, a second mode wherein the multimode clutch does not transmit torque from the wheel drive shaft to the first driven wheel and the second driven wheel when the wheel drive shaft rotates in either directions, and a third mode wherein the multimode clutch transmits torque from the wheel drive shaft to the first driven wheel and the second driven wheel when the wheel drive shaft rotates in one direction and does not transmit torque from the wheel drive shaft to the first driven wheel and the second driven wheel when the wheel drive shaft rotates in the other direction.

Additional aspects are defined by the claims of this patent.

### BRIEF DESCRIPTION OF THE DRAWINGS

FIG. 1 is a schematic illustration of an embodiment of an AWD vehicle in which one or more multimode clutch modules in accordance with the present disclosure may be implemented to disengage a set of front wheels from the powertrain;

FIG. 2 is a schematic illustration of an embodiment of an AWD vehicle in which one or more multimode clutch modules in accordance with the present disclosure may be implemented to disengage a set of rear wheels from the powertrain;

FIG. 3 is both a perspective and a cross-sectional view of a portion of one possible embodiment of a multimode clutch module that may be implemented in the AWD vehicles of FIGS. 1 and 2;

FIG. 4 is an enlarged side view of a portion of one possible embodiment of the multimode clutch module of FIG. 3 with the near inner race plate removed to reveal the internal components, and with an actuator cam in a one-way locked, one-way unlocked position;

FIG. 5 is the enlarge view of one possible embodiment of the multimode clutch module of FIG. 3 with the actuator cam in a two-way unlocked position;

FIG. 6 is the enlarge view of the multimode clutch module of FIG. 3 with the actuator cam in a two-way locked position;

FIG. 7 is a schematic illustration of an exemplary electronic control unit and control components that may be implemented in the AWD vehicles of FIGS. 1 and 2;

FIG. 8 is a schematic illustration of a front differential of the AWD vehicle of FIG. 1 having the multimode clutch module of FIG. 3 installed therein to perform a center axle disconnect of the set of front wheels;

FIG. 9 is a schematic illustration of the AWD vehicle of FIG. 1 having the multimode clutch module of FIG. 3 installed on each of the front half shafts;

FIG. 10 is a schematic illustration of the front differential of the AWD vehicle of FIG. 1 having the multimode clutch module of FIG. 3 installed therein to perform an inter-axle disconnect of the set of front wheels;

FIG. 11 is a schematic illustration of a transfer case of the AWD vehicle of FIG. 1 having the multimode clutch module of FIG. 3 installed therein to perform a transfer case disconnect of the set of front wheels; and

FIG. 12 is a schematic illustration of the transfer case of the AWD vehicle of FIG. 1 having the multimode clutch module of FIG. 3 and a friction clutch installed therein to perform a transfer case disconnect of the set of front wheels.

### DETAILED DESCRIPTION

Although the following text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning.

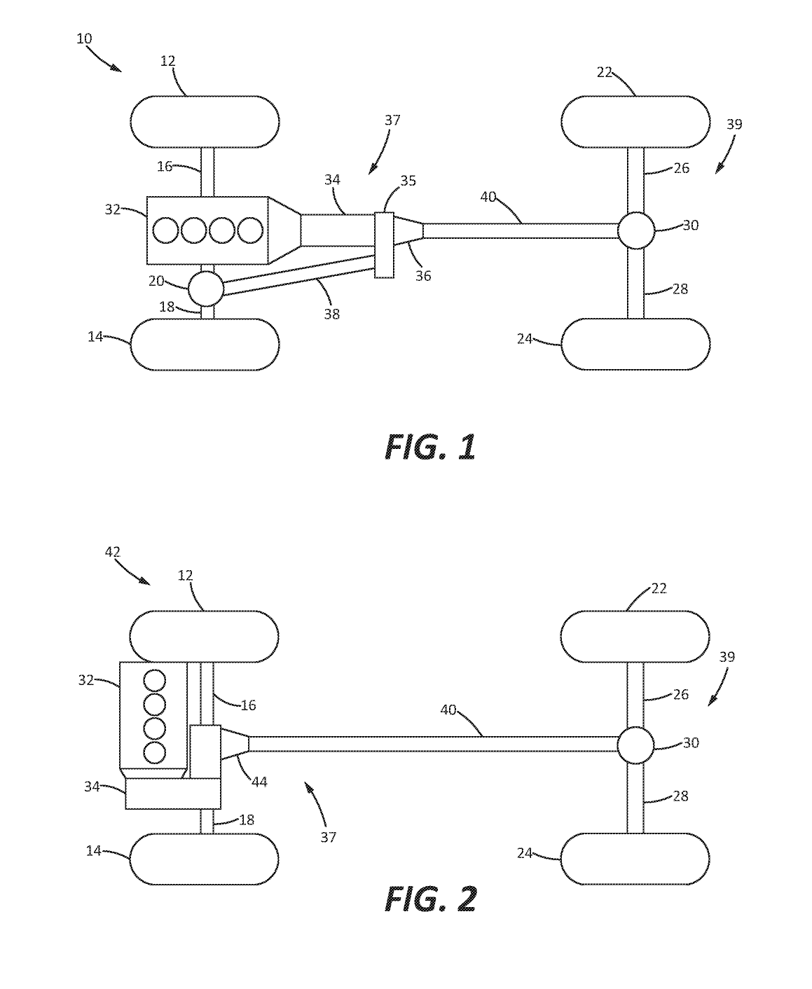

FIG. 1 is a schematic illustration of an exemplary AWD vehicle 10 known in the art. The AWD vehicle 10 includes a first or front set of driven wheels 12, 14 connected via front half shafts 16, 18 to a front differential 20, and a second or rear set of driven wheels 22, 24 mounted via rear half shafts 26, 28 to a rear differential 30. A power source 32, such as an internal combustion engine or an electric motor, may have an output shaft (not shown) operatively connected to a transmission or gearbox 34. The power source 32 is located at the front of the AWD vehicle 10, but the concepts discussed herein may be implemented in a similar manner in AWD vehicles having rear-mounted power sources. Internal gearing and a transmission output shaft 35 of the transmission 34 connect the power source 32 to a transfer case 36. The transfer case 36 may split the torque from the power source 32 and transmit the torque through the transmission 34 to both the front wheels 12, 14 and the rear wheels 22, 24. A front wheel drive shaft 38 may connect the transfer case 36 to the front differential 20, and a rear wheel drive shaft 40 may connect the transfer case 36 to the rear differential 30. With this arrangement, the transfer case 36, the front wheel drive shaft 38, the front differential 20 and the front half shafts 16, 18 may form a first or front driveline 37 to the front wheels 12, 14, and the transfer case 36, the rear wheel drive shaft 40, the rear differential 30 and the rear half shafts 26, 28 may form a second or rear driveline 39 to the rear wheels 22, 24

In the absence of any additional clutching arrangements, rotation of the transmission output shaft 35 by torque transmitted through the power source output shaft will cause corresponding rotation of both the front wheels 12, 14 and the rear wheels 22, 24. As will be discussed further in the embodiments below, the AWD vehicle 10 may perform as a rear-wheel drive vehicle when a multimode clutch is implemented and actuated to disengage the front wheels 12, 14 from the powertrain. FIG. 2 illustrates an example of an AWD vehicle 42 that may perform as a front-wheel drive vehicle when an implemented multimode clutch is actuated to disengage the rear wheels 22, 24 from the powertrain. In FIG. 2, similar components of the AWD vehicle 42 are identified using the same reference numerals as used for the elements of the AWD vehicle 10 in FIG. 1. In the AWD vehicle 42, the power source 32 may be transversely mounted at the front of the AWD vehicle 42, and the transmission 34 may provide torque to the front half shafts 16, 18 via a front wheel drive shaft 38 and a front differential 20 that are not visible in the schematic illustration. The transfer case 36 of the AWD vehicle 10 may be replaced by a power transfer unit (PTU) 44 operatively connected between the front differential 20 and the rear wheel drive shaft 40 to transfer power to the rear wheel drive shaft 40 and the rear wheels 22, 24. As illustrated and discussed later in the present disclosure, multimode clutches may be implemented in the AWD vehicle 42 in a manner to selectively disengage the rear wheels 22, 24 from the powertrain.

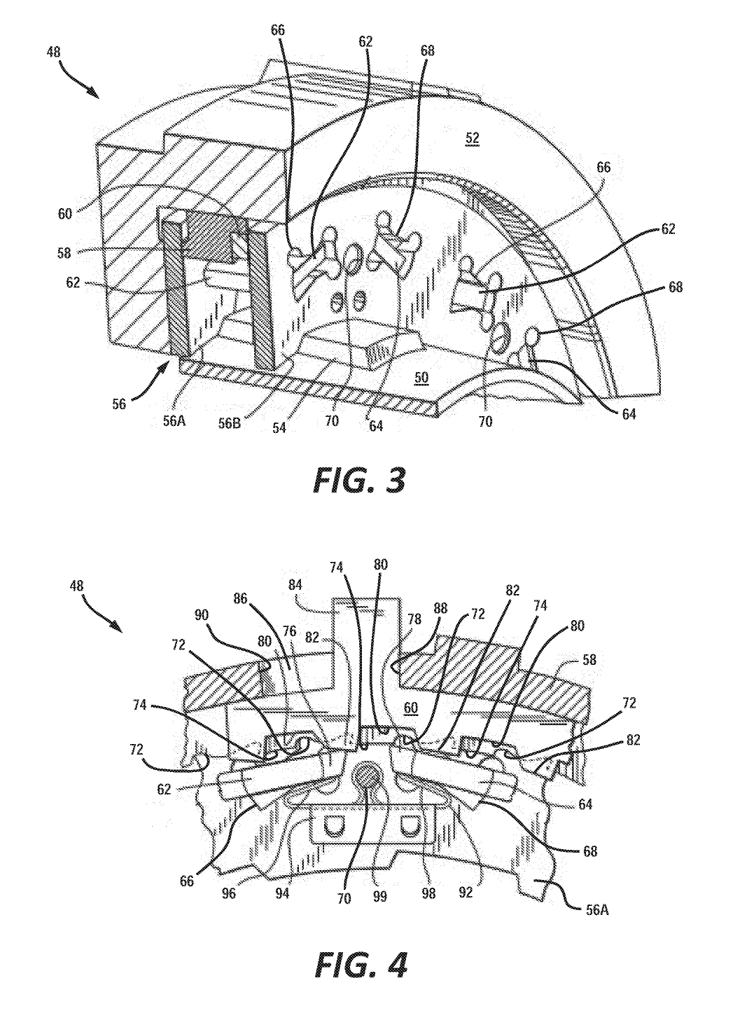

As discussed above, it may be desirable to disconnect either the front wheels 12, 14 or the rear wheels 22, 24 from the powertrain when the AWD functionality is not required. In accordance with the present disclosure, a multimode clutch module may be implemented at various locations of the AWD vehicle 10 to provide multiple modes for connecting and disconnecting the front wheels 12, 14 or the rear wheels 22, 24 to and from the powertrain. Referring to FIG. 3, a multimode clutch 48 of the AWD vehicle 10 may be utilized in lieu of the friction clutches and dog clutches used in previous AWD vehicles. The multimode clutch 48 may be of the type illustrated and described in Intl. Publ. No. WO 2014/120595 A1, published on Aug. 7, 2014, by Papania, entitled “Multi-Mode Clutch Module,” which is expressly incorporated by reference herein. In the illustrated embodiment, the multimode clutch 48 may incorporate an interior driven hub 50 and an outer housing 52 that may be locked for rotation together in some modes of the multimode clutch 48 and may be unlocked for independent rotation with respect to each other in other modes of the multimode clutch 48 as will be described more fully below. The driven hub 50 may contain an array of circumferentially spaced cogs 54 adapted to secure an inner race 56 to the driven hub 50 for rotation therewith. As disclosed, the inner race 56 is comprised of first and second spaced plates 56A and 56B. An outer race 58 sandwiched between the pair of inner race plates 56A, 56B, is situated so as to allow for relative rotation between inner race 56 and the outer race 58, and with the outer race 58 being operatively coupled to the outer housing 52 for rotation therewith.

In the present design of the multimode clutch 48, an actuator cam 60 is interposed between one of the race plates 56A, 56B and the outer race 58 for rotation over a predetermined angle about a common axis of the driven hub 50 and the outer housing 52 to control movements of pairs of opposed pawls 62, 64 as will be described further hereinafter. The sets of pawls 62, 64 are trapped, and hence retained, between the inner race plates 56A, 56B to allow limited angular movements of the pawls 62, 64 held within bowtie shaped apertures 66, 68, respectively, subject to the control of the actuator cam 60. In each set, the combined pawl 62 and corresponding aperture 66 is similar to but oppositely oriented to the combined pawl 64 and corresponding aperture 68. The elements of the multimode clutch 48 are contained within the outer housing 52. A plurality of spaced apertures 70 are adapted to accommodate rivets (not shown) for providing fixed and rigid securement of each of the two inner race plates 56A and 56B relative to the other.

The operational components of the multimode clutch 48 are illustrated in FIGS. 4-6 that illustrate the various operational modes of the multimode clutch 48 for controlling the relative rotation between the components attached to the driven hub 50 and the outer housing 52. Referring first to FIG. 4, the outer race 58 is configured to accommodate interactions with the pawls 62, 64 by providing the inner circumference of the outer race 58 with circumferentially spaced notches 72, each defined by and positioned between pairs of radially inwardly projecting cogs 74. The notches 72 and cogs 74 are configured so that, in the absence of the actuator cam 60, a toe end 76 of each pawl 62 enters one of the notches 72 and is engaged by the corresponding cog 74 when the driven hub 50 and the inner race 56 rotate in a clockwise direction as viewed in FIG. 4 relative to the outer housing 52 and the outer race 58 to cause the connected components to rotate together. Similarly, a toe end 78 of each pawl 64 enters one of the notches 72 and is engaged by the corresponding cog 74 when the driven hub 50 and the inner race 56 rotate in a counterclockwise direction relative to the outer housing 52 and the outer race 58 to cause the connected components to rotate together.

Within its interior periphery, the actuator cam 60 incorporates a strategically situated array of circumferentially spaced recesses, herein called slots 80, defined by and situated between projections, herein called cam teeth 82. The slots 80 and cam teeth 82 are adapted to interact with the pawls 62, 64 to control their movement within the apertures 66, 68, respectively, and disposition within the notches 72 and engagement by the cogs 74 as will be described. The actuator cam 60 may further include an actuator tab 84 or other appropriate member or surface that may be engaged by an actuator device (not shown) that is capable of causing the actuator cam 60 to move through its rotational range to the positions shown in FIGS. 4-6. The actuator device may be any appropriate actuation mechanism capable of moving the actuator cam 60, such as a hydraulic actuator such as that shown in the Papania reference cited above, a solenoid actuator, a pneumatic actuator or other appropriate device operatively coupled to the actuator cam and capable of rotating the actuator cam 60 to multiple positions. In the illustrated embodiment, the actuator tab 84 may be disposed within a slot 86 through the outer race and the rotation of the actuator cam 60 may be limited by a first limit surface 88 engaging the actuator tab 84 at the position shown in FIG. 4 and a second limit surface 90 engaging the actuator tab 84 at the position shown in FIG. 6.

The pawls 62, 64 are asymmetrically shaped, and reversely identical. Each of the opposed pawls 62, 64 is movably retained within its own bowtie-shaped pawl aperture 66, 68, respectively, of the inner race plates 56A and 56B. The toe end 76, 78 of each individual pawl 62, 64, respectively, is urged radially outwardly via a spring 92. Each spring 92 has a base 94, and a pair of spring arms 96 and 98. The spring arms 96 bear against the bottoms of the pawls 62, while the spring arms 98 bear against the bottoms of the pawls 64, each to urge respective toe ends 76, 78 into engagement with the cogs 74 of the outer race 58 when not obstructed by the cam teeth 82 of the actuator cam 60. It will be appreciated from FIG. 4 that axially extending rivets 99 are used to secure the inner race plates 56A, 56B together. The rivets 99 extend through the apertures 70 in each of the plates 56A, 56B to hold the two plates 56A, 56B rigidly together, and to thus assure against any relative rotation with respect to the plates 56A, 56B. In lieu of the rivets 99, other structural fasteners may be employed within the scope of this disclosure to secure the inner race plates 56A, 56B.

It will be appreciated that the actuator mechanism ultimately controls the actuator tab 84 which, in turn, moves the actuator cam 60 between multiple distinct angular positions. Thus, the positioning of the pawls 62, 64 as axially retained between the riveted inner race plates 56A, 56B is directly controlled by the actuator cam 60 against forces of springs 92. In FIG. 4, the actuator tab 84 is shown positioned by the actuator mechanism in a first, angularly rightward selectable position, representative of a first, one-way locked, one-way unlocked or open mode. In this position, the slots 80 and cam teeth 82 of the actuator cam 60 are positioned so that the toe ends 76 of the pawls 62 are blocked by cam teeth 82 from engagement with notches 72, and hence with the cogs 74 on the interior of the outer race 58. As such, the inner race 56 is enabled to freewheel relative to the outer race 58, and to thus provide for an overrunning condition when the inner race 56 and the driven hub 50 are rotating clockwise relative to the outer race 58 and the outer housing 52. Conversely, however, the position of the actuator cam 60 allows of the toe ends 78 of the pawls 64 to enter the slots 80 of the actuator cam 60 due to the biasing force of the spring arms 98, and to thereby directly engage the cogs 74 of the outer race 58 to lock the inner race 56 and the outer race 58 together whenever the inner race 56 and the driven hub 50 undergo a driving, or counterclockwise rotational movement, thereby causing the driven hub 50 and the outer housing 52 to rotate together.

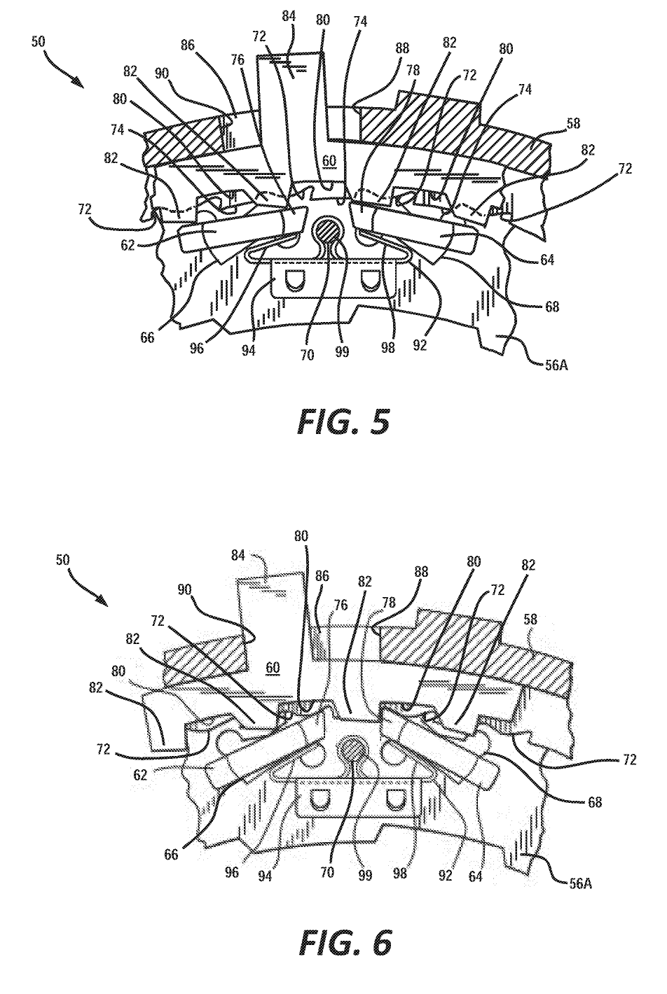

FIG. 5 illustrates the actuator tab 84 placed by the actuator mechanism in a second, intermediate selectable position, representative of a two-way unlocked or open mode of the multimode clutch 48. In this position, the slots 80 and the cam teeth 82 of the actuator cam 60 are positioned to prevent the toe ends 76, 78 of both pawls 62, 64 from entering the slots 80 of the actuator cam 60, and to maintain disengagement from the cogs 74 of the outer race 58. With the pawls 62, 64 blocked from engagement with the cogs 74, the inner race 56 and the driven hub 50 are enabled to freewheel relative to the outer race 58 and the outer housing 52 during relative rotation in either the clockwise or the counterclockwise direction.

In FIG. 6, the actuator tab 84 is shown in a third, angularly leftward selectable position, representative of a two-way locked mode of the multimode clutch 48. In this configuration, the actuator cam 60 is positioned so that the toe ends 76, 78 of both pawls 62, 64 enter the slots 80 of the actuator cam 60 under the biasing forces of the spring arms 96, 98 respectively, and are engaged by the cogs 74 of the outer race 58 as described above to lock the inner race 56 and the driven hub 50 to the outer race 58 and the outer housing 52 for rotation therewith, irrespective of the rotational direction of the inner race 56 and the driven hub 50.

Even though one specific embodiment of the multimode clutch 48 is illustrated and described herein, those skilled in the art will understand that alternative configurations of multimode clutches are possible that provide operational modes or positions as alternatives or in addition to two-way unlocked and two-way locked modes (FIGS. 5 and 6), and the one-way locked, one-way unlocked mode (FIG. 4). For example, an additional one-way locked, one-way unlocked mode that may provide for an overrunning condition when the inner race 56 and the driven hub 50 are rotating counter clockwise relative to the outer race 58 and the outer housing 52, and to lock the inner race 56 and the outer race 58 together whenever the inner race 56 and the driven hub 50 undergo a clockwise rotational movement so the driven hub 50 and the outer housing 52 rotate together. Moreover, alternate structures providing some or all of the modes discussed herein for the multimode clutches may be implemented in a similar manner in the AWD vehicles 10, 42, such as that illustrated and described in U.S. Pat. No. 5,079,453, published on Dec. 20, 2011, by Kimes, entitled “Controllable Overrunning Coupling Assembly.” The implementation of such alternative multimode clutches in AWD vehicles 10, 42 in accordance with the present disclosure would be within the capabilities of those skilled in the art and is contemplated by the inventors.

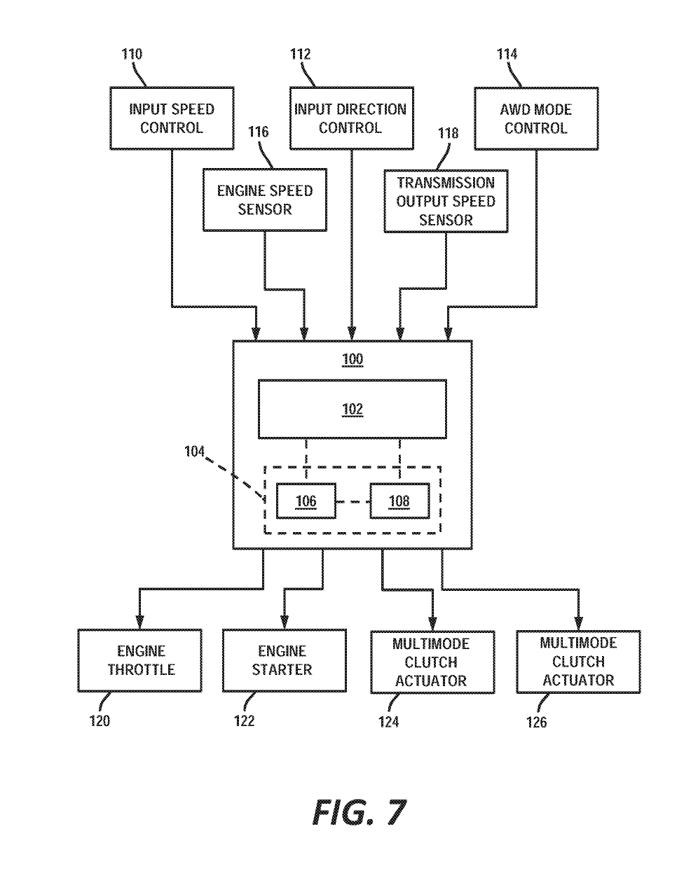

FIG. 7 illustrates one exemplary configuration of a controller 100 that may be implemented in the AWD vehicles 10, 42 to control the operations of the power source 32 and the transmission 34 to provide power to drive the AWD vehicles 10, 42, and of the multimode clutch 48 for selectively entering the one-way lock, one-way unlock mode of FIG. 4, the two-way unlock mode of FIG. 5 and the two-way lock mode of FIG. 6 as necessary based on the operating conditions for the AWD vehicles 10, 42. The controller 100 may include a microprocessor 102 for executing specified programs that control and monitor various functions associated with the AWD vehicles 10, 42, including functions that are outside the scope of the present disclosure. The microprocessor 102 includes a memory 104, such as read only memory (ROM) 106, for storing a program or programs, and a random access memory (RAM) 108 which serves as a working memory area for use in executing the program(s) stored in the memory 104. Although the microprocessor 102 is shown, it is also possible and contemplated to use other electronic components such as a microcontroller, an ASIC (application specific integrated circuit) chip, or any other integrated circuit device.

The controller 100 electrically connects to the control elements of the AWD vehicles 10, 42, as well as various input devices for commanding the operation of the vehicles 10, 42 and monitoring their performance. As a result, the controller 100 may be electrically connected to input devices detecting operator input and providing control signals to the controller 100 that may include an input speed control 110, such as a gas pedal or accelerator, that is manipulated by the operator to regulate the speed of the) AWD vehicles 10, 42, an input direction control 112, such as a gear shift or selection lever, that indicates a direction and/or a gear desired by the operator, and an AWD mode control that may allow the operator to manually select between options such as two-wheel drive, full time all-wheel drive and automatic all-wheel drive modes. The controller 100 may also be connected to sensing devices providing control signals with values indicating real-time operating conditions of the AWD vehicles 10, 42, such as an engine speed sensor 116 that measures an output speed of the power source 32, such as a rotary speed sensor measuring the rotational speed of the power source output shaft, and a transmission output speed sensor 118 that measures the rotational speed output by the transmission 34 or the transfer case 36, such as a rotary speed sensor measuring the rotational speed of the transmission output shaft 35 (FIG. 1). The controller 100 may also be electrically connected to output devices to which control signals are transmitted and from which control signals may be received by the controller 100, such as, for example, an engine throttle 120 that may control the speed of the power source 32, an engine starter 122 that may be configured to start up and shut down the power source 32 of the AWD vehicles 10, 42, and one or more multimode clutch actuators 124, 126 that may be part of the actuation mechanisms that move one or more multimode clutches 48 that may be implemented between the various operating modes of FIGS. 4-6.

An operator of the AWD vehicles 10, 42 may manipulate the input speed control 110 to generate and transmit control signals to the controller 100 with commands indicating a desired increase or decrease in the speed of the AWD vehicles 10, 42, and the speed sensors 116, 118 generate and transmit control signals indicating the current speed of the power source 32 and of the transmission output shaft 35 (FIG. 1). The controller 100 may then determine any necessary changes for the operational states of the power source 32 and the transmission 34 and transmit appropriate control signals to the engine throttle 120 and the transmission 34 to change the engine speed and, correspondingly, the speed of the AWD vehicles 10, 42, as commanded by the operator. Those skilled in the art will understand that the input devices, output devices and operations of the controller 100 described herein are exemplary only, and that additional and alternative devices may be implemented in AWD vehicles 10, 42 in accordance with the present disclosure to monitor the operations of the AWD vehicles 10, 42 and inputs provided by operators of the AWD vehicles 10, 42, and to control the power source 32, the multimode clutch 48 and other systems of the AWD vehicles 10, 42 to operate in a desired manner.

The AWD mode control 114 and/or the controller 100 may control the switching of the multimode clutch 48 between the available drive modes. The AWD mode control 114 may allow an operator to manually control the mode of the multimode clutch 48. When the AWD mode control 114 is in an all-wheel drive mode position, the controller 100 may transmit clutch mode control signals to the multimode clutch actuators 124, 126 to move the actuator cam 60 to the two-way locked position of FIG. 6 for all-wheel drive in both directions or the one-way locked/one-way unlocked position of FIG. 4 for all-wheel drive in one direction. When the AWD mode control 114 is in a two-wheel drive mode position, the controller 100 may transmit clutch mode control signals to the multimode clutch actuators 124, 126 to move the actuator cam 60 to the two-way unlocked position of FIG. 5 for two -wheel drive using either the front wheels 12, 14 or the rear wheels 22, 24.

The controller 100 of the AWD vehicles 10, 42 may also or alternatively be configured to automatically shift into and out of all-wheel drive mode in real time based on the operating conditions of the AWD vehicles 10, 42. The automatic AWD mode may be active at all times, or may be commanded via an additional position of the AWD mode control 114. When in the automatic AWD mode, the controller 100 may determine when the conditions do not require all-wheel drive, such as when control signals from the engine speed sensor 116, the transmission output speed sensor 118 or other sensors indicate that the AWD vehicle 10, 42 is at a cruising speed. In response, the controller 100 may transmit clutch mode control signals to the multimode clutch actuators 124, 126 to move the actuator cam 60 to the two-way unlocked position of FIG. 5. When the controller 100 determines when that the conditions require all-wheel drive, such as when one or more of the wheels 12, 14, 22, 24 slip or in other conditions typically used in previous automatic all-wheel drive vehicles where torque is required for all four wheels 12, 14, 22, 24, the controller 100 may respond by transmitting clutch mode control signals to the multimode clutch actuators 124, 126 to move the actuator cam 60 to the two-way locked position of FIG. 6 or the one-way locked/one-way unlocked position of FIG. 4 so that all four wheels 12, 14, 22, 24 are driven in the forward direction.

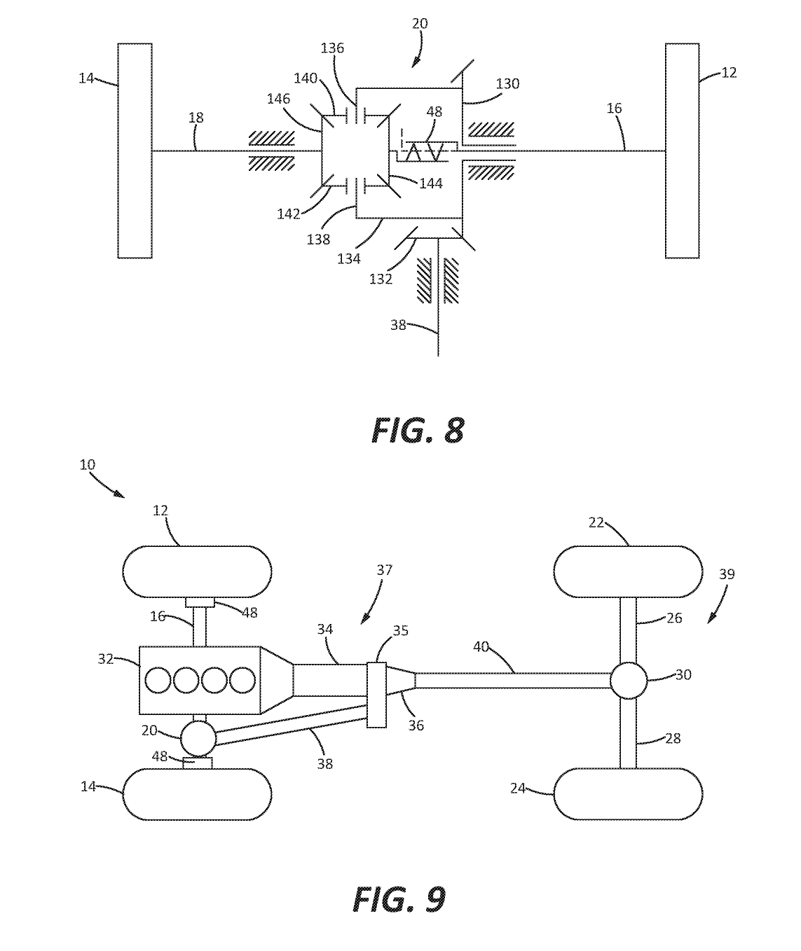

The multimode clutch 48 as disclosed herein may be implemented at various locations throughout the powertrains of the AWD vehicles 10, 42 to provide selective disengagement of either the front wheels 12, 14 or the rear wheels 22, 24 to shift from all-wheel drive to two-wheel drive when desirable. FIG. 8 illustrates one example where the multimode clutch 48 may be implemented within the front differential 20 of the AWD vehicle 10 to provide selective disengagement of the front wheels 12, 14. The front differential 20 may be of a type known in the art, and may include a ring gear 130 that is rotatable about a rotational axis of the front half shafts 16, 18 and meshes with and is driven by a pinion gear 132 connected to an end of the front wheel drive shaft 38. The ring gear 130 may be mounted to a differential case 134 that rotates with the ring gear 130 and has inwardly extending pins 136, 138 serving as rotational shafts for a pair of spider gears 140, 142, respectively. A pair of side gears 144, 146 are mounted for rotation with the front half shafts 16, 18, respectively, and mesh with the spider gears 140, 142 so that input rotation of the front wheel drive shaft 38 will cause the front wheels 12, 14 to turn and propel the AWD vehicle 10 in the manner known in the art for differential gear sets.

In the illustrated embodiment, the multimode clutch 48 may be interposed within the front differential 20 between the front half shaft 16 and the corresponding side gear 144 to provide selective disengagement of power to the front wheels 12, 14. The front half shaft 16 may be connected to the interior driven hub 50 and the side gear 144 may be connected to the outer housing 52, or vice versa. With the multimode clutch 48, the front half shaft 16 and the side gear 144 may be locked for rotation together when the multimode clutch 48 is in the position shown in FIG. 6, may be free to rotate independently when the multimode clutch 48 is in the two-way unlocked position of FIG. 5, and may rotate together in one direction and independently in the opposite direction when the multimode clutch 48 is in the position of FIG. 4. When the front half shaft 16 and the side gear 144 are unlocked, torque from the power source 32 cannot be transmitted to either front wheel 12, 14 by the front differential 20, and the AWD vehicle 10 will be in a two-wheel drive mode with all torque transmitted to the rear wheels 22, 24.

The one-way locked/one-way unlocked mode of the multimode clutch 48 may be particularly useful in low-speed driving situations where the front wheels 12, 14 may travel farther in a turn (i.e, faster rotation of the front half shafts 16, 18) than dictated by the rotation of the front wheel drive shaft 38. In this situation, the multimode clutch 48 may allow the front half shafts 16, 18 to overrun the speed of the front wheel drive shaft 38 to prevent the condition known as “crop hop” where either the front wheels 12, 14 or the rear wheels 22, 24 slip because they are rotating at different speeds. Depending on the implementation, the controller 100 by default may set the multimode clutch 48 to the position of FIG. 4 in the all-wheel drive mode to handle the overrun condition at any time. Alternatively, the controller 100 may be configured to determine based on current operating information from sensors such as the sensors 116, 118 that the AWD vehicle 10 is traveling at a low speed where the overrun condition may occur, and transmit clutch mode control signals to cause the multimode clutch actuator 124 to place the multimode clutch 48 in the position of FIG. 4 during those conditions.

The center axle disconnect strategy of FIG. 8 may be implemented in alternative forms. For example, the multimode clutch 48 may be installed between the other front half shaft 18 and the side gear 146. The multimode clutch 48 could also be installed between the front wheel drive shaft 38 and the pinion gear 132 to selectively cut off torque to the front differential 20 entirely. In the AWD vehicle 42, the multimode clutch 48 may be installed in the rear differential 30 at similar locations to selectively disengaged the rear wheels 22, 24 from the powertrain. The multimode clutch 48 may also be installed in a similar manner in the PTU 44 in the AWD vehicle 42. The multimode clutch 48 could also be installed between the rear wheel drive shaft 40 and a pinion gear (not shown) of the PTU 44 that operatively coupled to the front differential 20 to selectively cut off torque transferred from the front differential 20 to the rear wheel drive shaft 40 by the PTU 44.

In the embodiments discussed in relation to FIG. 8, hydraulic losses due to oil turning in the front differential 20 are reduced but not completely eliminated as the internal components continue to rotate even though no torque is being transferred. FIG. 9 illustrates an alternative embodiment wherein the multimode clutch 48 is installed at hubs (not shown) of each of the front wheels 12, 14 of the AWD vehicle 10. On one side, a first multimode clutch 48 may have the interior driven hub 50 connected to the wheel hub of the front wheels 12 and the outer housing 52 connected to the end of the front half shafts 16, or vice versa. A second multimode clutch 48 is similarly installed between the wheel hub of the front wheel 14 and the front half shaft 18. The first and second multimode clutches 48 may be operatively connected to the first and second multimode clutch actuators 124, 126, respectively. When the AWD mode control 114 is actuated or the controller 100 otherwise determines that the mode is to change from all-wheel drive to two-wheel drive or vice versa, the controller 100 may transmit clutch mode control signals to both multimode clutch actuators 124, 126 to move the actuator cams 60 to the appropriate positions. In two-wheel drive mode with the connections between both front wheels 12, 14 and the front differential 20 broken, the front wheels 12, 14 and the front half shafts 16, 18 are not rotating the components of the front differential 20, thereby further reducing the hydraulic losses due to oil churning within the front differential 20. Of course, those skilled in the art will understand that a similar arrangement may be implemented in the AWD vehicle 42 by installing the multimode clutches 48 between the rear wheels 22, 24 and the rear half shafts 26, 28.

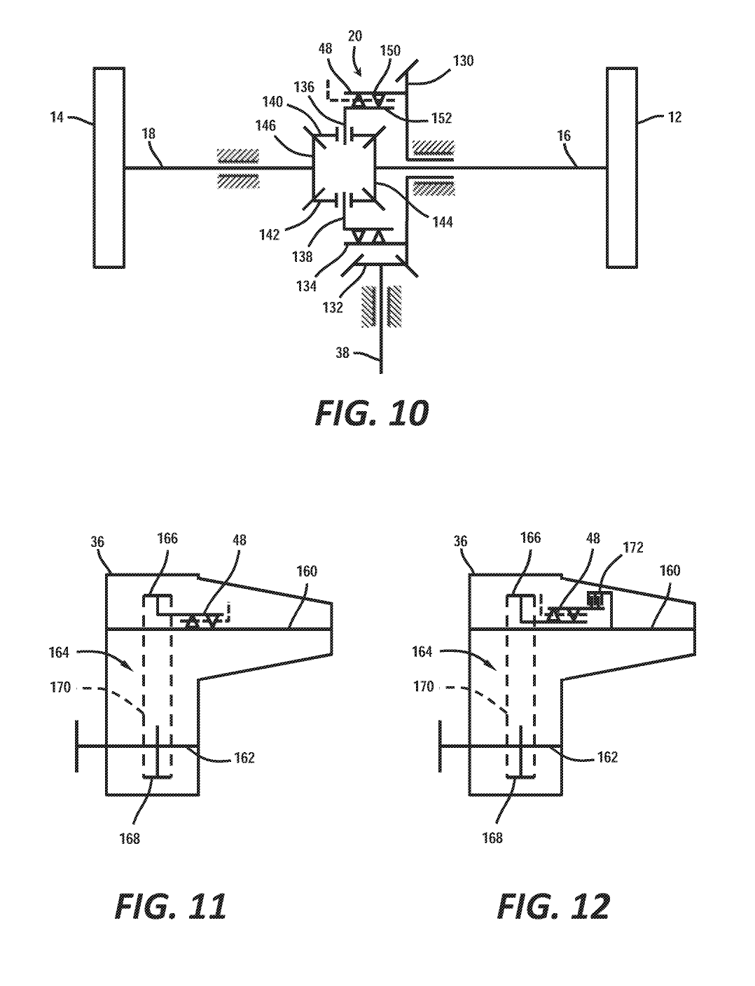

FIG. 10 illustrates a further alternative embodiment where the multimode clutch 48 is implemented within the front differential 20 and an alternate location. In this) embodiment, the differential case 134 may be separated into an outer differential case portion 150 that is connected to and rotates with the ring gear 130, and an inner differential case portion 152 that carries the pins 136, 138 and the spider gears 140, 142. The interior driven hub 50 may be connected to one of the differential case portions 150, 152 and the outer housing 52 may be connected to the other differential case portion 150, 152. When the multimode clutch 48 is unlocked, the ring gear 130 and the outer differential case portion 150 can rotate independent of the inner differential case portion 152 so that torque from the powertrain is not transferred to the front wheels 12, 14. As with other embodiments, the multimode clutch 48 may be installed in the rear differential 30 in the AWD vehicle 42 to disengage the rear wheels 22, 24. Similar to the embodiment of FIG. 8, this inter-axle disconnect arrangement reduces the hydraulic losses within the differentials 20, 30 by reducing the rotation of the parts therein.

In further alternative embodiments, one set of driven wheels can be selectively disengaged by breaking the connection of the corresponding drive shaft 38, 40 to the powertrain. In one implementation, the multimode clutch 48 may be installed between two portions of the front wheel drive shaft 38 in the AWD vehicle 10 or the rear wheel drive shaft 40 in the AWD vehicle 42, and selectively actuated to disengage the shaft portions from each other. In other embodiments, the multimode clutch 48 may be installed within the transfer case 36 to selectively disconnect the power transfer mechanism that divides the torque from the power source 32 between the wheel drive shaft 38, 40. FIG. 11 is a schematic illustration of an exemplary power transfer mechanism of the transfer case 36. The power transfer mechanism may include a first power transfer shaft 160 operatively connected at one end to the transmission output shaft 35 (FIG. 1) and at the opposite end to the one of the wheel drive shaft 38, 40 that will receive power in the two-wheel drive mode. A second power transfer shaft 162 may be connected to the other of the wheel drive shafts 38, 40 that will be disengaged from the powertrain.

The power transfer shafts 160, 162 may be connected by a drive mechanism 164 causing the second power transfer shaft 162 to rotate in response to rotation of the first power transfer shaft 160. The drive mechanism 164 in the illustrated embodiment may be a chain drive having a first sprocket 166 mounted on and rotatable with the first power transfer shaft 160, a second sprocket 168 mounted on and rotatable with the second power transfer shaft 162, and a chain 170 around the sprockets 166, 168 and engaged by teeth of the sprockets 166, 168 so that the first power transfer shaft 160 drives the second power transfer shaft 162 when rotated by the transmission output shaft 35 (FIG. 1). In alternative embodiments, the chain drive may be replaced by meshing gears, a drive belt and pulleys, of other appropriate drive mechanisms 164 for concurrent rotation of the power transfer shafts 160, 162.

In the transfer case 36 as described, disengagement of the drive mechanism 164 and, consequently, the second power transfer shaft 162 may be achieved by installing the multimode clutch 48 between the first power transfer shaft 160 and the first sprocket 166 as shown. The interior driven hub 50 of the multimode clutch 48 may be connected to the first power transfer shaft 160 and the outer housing 52 may be connected to the first sprocket 166, or vice versa. In this arrangement, the first power transfer shaft 160 and the first sprocket 166 may be locked for rotation together and all-wheel drive in both directions (FIG. 6), may be unlocked to disable all-wheel drive in both directions (FIG. 5), or one-way locked/one-way unlocked (FIG. 4). When the multimode clutch 48 is unlocked, the first power transfer shaft 160 will rotate independent of the first sprocket 166 so that torque is not transferred to the second power transfer shaft 162 by the drive mechanism 164. In an alternative embodiment, the multimode clutch 48 may be installed in a similar manner between the second power transfer shaft 162 and the second sprocket 168.

In some all-wheel drive applications, it may be desirable to allow for some slippage between the power transfer shafts 160, 162 within the transfer case 36 under certain torque distribution conditions. FIG. 12 illustrates an embodiment of the transfer case 36 where a friction clutch 172 may be provided to connect the first power transfer shaft 160 to the first sprocket 166. The friction clutch 172 may allow a desired amount of slippage between the first power transfer shaft 160 and the first sprocket 166 under high torque conditions. In this embodiment, the multimode clutch 48 may be installed between the first sprocket 166 and the friction clutch 172 for selective disengagement to alternate between all-wheel drive and two-wheel drive. In a further alternative embodiment, the multimode clutch 48 may be installed between the first power transfer shaft 160 and the friction clutch 172, with the first sprocket 166 and the friction clutch 172 maintaining constant contact and simultaneous rotation with the exception of the anticipated slippage within the friction clutch 172.

### INDUSTRIAL APPLICABILITY

The multimode clutch 48 may serve as a replacement for dog clutches and friction clutches in locations within the powertrain that currently utilize such devices. The multimode clutch 48 as described herein may also occupy new locations within the powertrain to take advantage of the unique engagement characteristics and low drag torque of the multimode clutch 48. As illustrated in FIGS. 4-6, the actuator tab 84 of the actuator cam 60 requires a relatively low amount of actuator travel and actuator force to move the actuator cam 60 between the three positions shown in the drawings. The travel distance and force may be significantly less than the distance in force required to move the replaced dog clutches and friction clutches between their engaged and disengaged modes. Such reductions in travel distance and force facilitate corresponding reductions in the size and mass of the multimode clutch actuators 124, 126 relative to the actuators of the replaced clutches, which can improve the efficiency of the AWD vehicles 10, 42, and reduce the cost of the clutching systems. Moreover, further efficiency improvements may be realized as a result of the low drag torque present when the multimode clutch 48 is unlocked in the interior driven hub 50 rotates relative to the outer housing 52. In addition, the overall performance of the AWD vehicles 10, 42 may be improved by providing a single clutching mechanism with the capability of providing connections between) components of the powertrain that can provide each of the three distinct clutch modes presented in FIGS. 4-6.

While the preceding text sets forth a detailed description of numerous different) embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

What is claimed is:

1. An all-wheel drive (AWD) vehicle (10, 42), comprising:
a first set of driven wheels (12, 14);
a second set of driven wheels (22, 24);
a power source (32);
a transmission (34) operatively connected to the power source (32) and receiving power output by the power source (32), the transmission (34) having a transmission output shaft (35);
a first wheel driveline (37) operatively connected between the power source (32) output shaft and the first set of driven wheels (12, 14) to transfer power from the power source (32) to rotate the first set of driven wheels (12, 14);
a second wheel driveline (39) operatively connected between the power source (32) output shaft and the second set of driven wheels (22, 24) to transfer power from the power source (32) to rotate the second set of driven wheels (22, 24); and
a multimode clutch (48) within the first wheel driveline (37) to allow the first driveline (37) to selectively transmit power from the power source (32) to the first set of driven wheels (12, 14), wherein the multimode clutch (48) has a first mode wherein the multimode clutch (48) transmits torque from the power source (32) to the first set of driven wheels (12, 14) when the transmission output shaft (35) rotates in either direction, a second mode wherein the multimode clutch (48) does not transmit torque from the power source (32) to the first set of driven wheels (12, 14) when the transmission output shaft (35) rotates in either directions, and a third mode wherein the multimode clutch (48) transmits torque from the power source (32) to the first set of driven wheels (12,14) when the transmission output shaft (35) rotates in one direction and does not transmit torque from the power source (32) when the transmission output shaft (35) rotates in the other direction.

2. The AWD vehicle (10, 42) according to claim 1, wherein the first set of driven wheels (12, 14) comprises a first driven wheel (12) and a second driven wheel (14), and wherein the first driveline comprises (37):
a first half shaft (16) having a first end connected to the first driven wheel (12);
a second half shaft (18) having a first end connected to the second driven wheel (14); and
a first differential (20) having a first side gear (144) connected to a second end of the first half shaft (16), a second side gear (146) connected to a second end of the second half shaft (18) by the multimode clutch (48), wherein the multimode clutch (48) causes the second side gear (146) and the second half shaft (18) to rotate together in both directions when the multimode clutch (48) is in the first mode, the multimode clutch (48) allows the second side gear (146) and the second half shaft (18) to rotate independent of each other in both directions when the multimode clutch (48) is in the second mode, and the multimode clutch (48) causes the second side gear (146) and the second half shaft (18) to rotate together in one direction and allows the second side gear (146) and the second half shaft (18) to rotate independent of each other in the opposite direction when the multimode clutch (48) is in the third mode.

3. The AWD vehicle (10, 42) according to claim 1, wherein the first set of driven wheels (12, 14) comprises a first driven wheel (12) and a second driven wheel (14), wherein the multimode clutch (48) comprises a first multimode clutch (48) and a second multimode clutch (48), and wherein the first driveline (37) comprises:
a first half shaft (16) having a first end connected to the first driven wheel (12) by the first multimode clutch (48); and
a second half shaft (18) having a first end connected to the second driven wheel (14) by the second multimode clutch (48), wherein the first and second multimode clutches (48) cause the first and second driven wheels (12, 14) and the first and second half shafts (16, 18) to rotate together in both directions when the first and the second multimode clutches (48) are in the first mode, the first and second multimode clutches (48) allow the first and second driven wheels (12,14) and the first and second half shafts (16,18) to rotate independent of each other in both directions when the first and second multimode clutches (48) are in the second mode, and the first and second multimode clutches (48) cause the first and second driven (12, 14) wheels and the first and second half shafts (16, 18) to rotate together in one direction and allow the first and second driven wheels (12, 14) and the first and second half shafts (16, 18) to rotate independent of each other in the opposite direction when the first and second multimode clutches (48) are in the third mode.

4. The AWD vehicle (10, 42) according to claim 1, wherein the first set of driven wheels (12, 14) comprises a first driven wheel (12) and a second driven wheel (14), and wherein the first driveline (37) comprises:
a first half shaft (16) having a first end connected to the first driven wheel (12);
a second half shaft (18) having a first end connected to the second driven wheel (14);
a first wheel drive shaft (38) having a first end operatively connected to the transmission output shaft (35); and
a first differential (20) disposed between a second end of the first half shaft (16) and a second end of the second half shaft (18) and operatively connected to a second end of the first wheel drive shaft (38), wherein the first differential (20) comprises:
a pinion gear (132) connected to the second end of the first wheel drive shaft (38),
a first side gear (144) connected to the second end of the first half shaft (16),
a second side gear connected (146) to the second end of the second half shaft (18),
a ring gear (130) meshing with the pinion gear (132),
a first spider gear (140) and a second spider gear (142) meshing with the first side gear (144) and the second side gear (146), and
a differential case (134) having a first differential case portion (150) connected to the ring gear (130) and a second differential case portion (152) having the first and second spider gears (140, 142) mounted thereon, wherein the first differential case portion (150) and the second differential case portion (152) are connected by the multimode clutch (48) and the multimode clutch (48) causes the first differential case portion (150) and the second differential case portion (152) to rotate together in both directions when the multimode clutch (48) in the first mode, the multimode clutch (48) allows the first differential case portion (150) and the second differential case portion (152) to rotate independent of each other in both directions when the multimode clutch (48) is in the second mode, and the multimode clutch (48) causes the first differential case portion (150) and the second differential case portion (152) to rotate together in one direction and allows the first differential case portion (150) and the second differential case portion (152) to rotate independent of each other in the opposite direction when the multimode clutch (48) is in the third mode.

5. The AWD vehicle (10, 42) according to claim 1, wherein the first wheel driveline (37) comprises a first wheel drive shaft (38) and the second wheel driveline (39) comprises a second wheel drive shaft (40), the AWD vehicle comprises (10, 42):
a transfer case comprising (36):
a first power transfer shaft (160) having a first end connected to the transmission output shaft (35) and a second end connected the second wheel drive shaft (40),
a second power transfer shaft (162) having a first end connected to the first wheel drive shaft (38), and
a drive mechanism (164) operatively connecting the first power transfer shaft (160) to the second power transfer shaft (162) such that rotation of the first power transfer shaft (160) causes rotation of the second power transfer shaft (162), wherein the first power transfer shaft (160) and the drive mechanism (164) are connected by the multimode clutch (48) and the multimode clutch (48) causes the first power transfer shaft (160) and the drive mechanism (164) to rotate together in both directions when the multimode clutch (48) in the first mode, the multimode clutch (48) allows the first power transfer shaft (160) and the drive mechanism (164) to rotate independent of each other in both directions when the multimode clutch (48) is in the second mode, and the multimode clutch (48) causes the first power transfer shaft (160) and the drive mechanism (164) to rotate together in one direction and allows the first power transfer shaft (160) and the drive mechanism (164) to rotate independent of each other in the opposite direction when the multimode clutch (48) is in the third mode.

6. The AWD vehicle (10, 42) according to claim 5, wherein the transfer case (36) comprises a friction clutch (172) connected to one of the first power transfer shaft (160) and the drive mechanism (164), and wherein the friction clutch (172) and the other of the first power transfer shaft (160) and the drive mechanism (164) are connected by the multimode clutch (48).

7. The AWD vehicle (10, 42) according to claim 5, wherein the multimode clutch (48) has a fourth mode wherein the multimode clutch (48) transmits torque from the power source (32) to the first set of driven wheels (12, 14) when the transmission shaft (35) rotates in the opposite direction of the multimode clutch (48) transmitting torque in the third mode and does not transmit torque from the power source (32) when the transmission shaft (35) rotates in the other direction.

8. The AWD vehicle (10, 42) according to claim 1, wherein a multimode clutch actuator (124, 126) operatively connected to the multimode clutch (48) and being configured to selectively place the multimode clutch (48) in the first mode, the second mode and the third mode, and a controller (100) operatively connected to the multimode clutch actuator (124, 126), the controller (100) being configured to transmit clutch mode control signals to the multimode clutch actuator (124, 126) to cause the multimode clutch actuator (124, 126) to place the multimode clutch (48) in the first mode, the second mode and the third mode.

9. The AWD vehicle (10, 42) according to claim 8, wherein a plurality of sensors (116, 118) being operatively connected to the controller (100), the plurality of sensors (116, 118) sense a plurality of operating parameters of the AWD vehicle (10, 42) and transmit sensor signals to the controller (100) containing values of the plurality of operating parameters, wherein the controller (100) being configured to transmit clutch mode control signals to the multimode clutch actuator (124, 126) to place the multimode clutch (48) in the first mode, the second mode and the third mode.

10. A differential (20) for an all-wheel drive (AWD) vehicle (10, 42) having a first driven wheel (12) mounted on a first half shaft (16), and second driven wheel (14) mounted on a second half shaft (18), and a wheel drive shaft (38) operatively connected to a transmission output shaft (35) of a transmission (34) that receives power from a power source (32) of the AWD vehicle (10, 42), the differential (20) comprising:
a pinion gear (132) operatively connected to the wheel drive shaft (38);
a first side gear (144) operatively connected to the first half shaft (16);
a second side gear (146) operatively connected to the second half shaft (18);
a ring gear (130) meshing with the pinion gear (132);
a first spider gear (140) and a second spider gear (142) meshing with the first side gear (144) and the second side gear (146);
a differential case (134) connected to the ring gear (130) and having the first spider gear (140) and the second spider gear (142) mounted thereto; and
a multimode clutch (48) allowing the differential (20) to selectively transmit power from the power source (32) to the first driven wheel (16) and the second driven wheel (18), wherein the multimode clutch (48) has a first mode wherein the multimode clutch (48) transmits torque from the wheel drive shaft (38) to the first driven wheel (16) and the second driven wheel (18) when the wheel drive shaft (38) rotates in either direction, a second mode wherein the multimode clutch (48) does not transmit torque from the wheel drive shaft (38) to the first driven wheel (16) and the second driven wheel (18) when the wheel drive shaft (38) rotates in either directions, and a third mode wherein the multimode clutch (48) transmits torque from the wheel drive shaft (38) to the first driven wheel (16) and the second driven wheel (18) when the wheel drive shaft (38) rotates in one direction and does not transmit torque from the wheel drive shaft (38) to the first driven wheel (16) and the second driven wheel (18) when the wheel drive shaft (38) rotates in the other direction.

11. The differential (20) according to claim 10, wherein the multimode clutch (48) operatively connects the first half shaft (16) to the first side gear (144) and the second half shaft (18) to the second side gear (146), and wherein the multimode clutch (48) causes the first and second half shafts (16, 18) and the first and second side gears (144, 146) to rotate together in both directions when the multimode clutch (48) is in the first mode, the multimode clutch (48) allows the first and second half shafts (16, 18) and the first and second side gears (144, 146) to rotate independent of each other in both directions when the multimode clutch (48) is in the second mode, and the multimode clutch causes (48) the first and second half shafts (16, 18) and the first and second side gears (144, 146) to rotate together in one direction and allows the first and second half shafts (16, 18) and the first and second side gears (144, 146) to rotate independent of each other in the opposite direction when the multimode clutch (48) is in the third mode.

12. The differential (20) according to claim 10, wherein the multimode clutch (48) operatively connects the pinion gear (132) to the wheel drive shaft (38), and wherein the multimode clutch (48) causes the pinion gear (132) and the wheel drive shaft (38) to rotate together in both directions when the multimode clutch (48) is in the first mode, the multimode clutch (48) allows the pinion gear (132) and the wheel drive shaft (38) to rotate independent of each other in both directions when the multimode clutch (48) is in the second mode, and the multimode clutch (48) causes the pinion gear (132) and the wheel drive shaft (38) to rotate together in one direction and allows the pinion gear (132) and the wheel drive shaft (38) to rotate independent of each other in the opposite direction when the multimode clutch (48) is in the third mode.

13. The differential (20) according to claim 10, wherein the differential case (134) comprises:
a first differential case portion (150) connected to the ring gear (130); and
a second differential case portion (152) having the first and second spider gears (140, 142) mounted thereon, wherein the first differential case portion (150) and the second differential case portion (152) are connected by the multimode clutch (48) and the multimode clutch (48) causes the first differential case portion (150) and the second differential case portion (152) to rotate together in both directions when the multimode clutch (48) in the first mode, the multimode clutch (48) allows the first differential case portion (150) and the second differential case portion (152) to rotate independent of each other in both directions when the multimode clutch (48) is in the second mode, and the multimode clutch (48) causes the first differential case portion (150) and the second differential case portion (152) to rotate together in one direction and allows the first differential case portion (150) and the second differential case portion (152) to rotate independent of each other in the opposite direction when the multimode clutch (48) is in the third mode.

14. The differential (20) according to claim 10, wherein the AWD vehicle (10, 42) includes a controller 100, the differential (20) comprising a multimode clutch actuator (124, 126) operatively connected to the multimode clutch (48) and to the controller (100) and configured to selectively place the multimode clutch (100) in the first mode, the second mode and the third mode, wherein the multimode clutch actuator (124, 126) receives clutch mode control signals from the controller (100) and causes the multimode clutch (48) to move between the first mode, the second mode and the third mode in response to the multimode clutch control signals.

15. The differential (20) according to claim 10 wherein the multimode clutch (48) comprises:
an interior driven hub (50);
an outer housing (52) operatively connected to the interior driven hub (50) so that the outer housing (52) can rotate independent of the interior driven hub (50); and
an actuator cam (60) operatively connected between the interior driven hub (50) and the outer housing (52) and having a first cam position placing the multimode clutch (48) in the first mode and causing the interior driven hub (50) and the outer housing (52) to rotate together in both directions, a second cam position placing the multimode clutch (48) in the second mode and allowing the interior driven hub (50) and the outer housing (52) to rotate independent of each other in both directions, and a third cam position placing the multimode clutch (48) in the third mode and causing the interior driven hub (50) and the outer housing (52) to rotate together in one direction and allowing the interior driven hub (50) and the outer housing (52) to rotate independent of each other in the opposite direction.
